(19) United States
(12) Patent Application Publication
(10) Pub. No.: US 2004/0047939 A1
(43) Pub. Date: Mar. 11, 2004

(54) Thermoforming tool

(76) Inventors: Matthias Frank, Nordheim (DE); Hans Masche, Eppingen (DE)

Correspondence Address: Ronald E. Greigg, Greigg & Greigg, P.L.L.C., 1423 Powhatan Street, Alexandria, VA, 22314, US

(21) Appl. No.: 10/658,403

(22) Filed: Sep. 10, 2003

(30) Foreign Application Priority Data
Sep. 11, 2002 (DE) 2 02 14 006.7

(51) Int. Cl. B29C 51/20

(52) U.S. Cl. 425/501; 425/3

(57) ABSTRACT

The invention relates to a thermoforming device including a forming tool having at least one mold opening and means with which a plastically deformable sheet material can be brought into contact with the inner wall of the mold opening. A first parting tool is connected to a first support element and has at least one first parting edge extending around the rim of the mold opening and a second parting tool, which is connected to a second support element has at least a second parting edge which cooperates with the first parting edge on the first parting tool. At least one of the parting tools is made from a different material than its associated support element. The first parting tool is not supported or fastened rigidly relative to the first support element, and/or the second parting tool is not supported or fastened rigidly relative to the second support element.

### BACKGROUND OF THE INVENTION

1. Field of the Invention

The invention relates to an improved thermoforming device, and more particularly to a thermoforming device having a forming tool in which there is at least one mold opening and means with which a plastically deformable sheet material can be brought into contact with the innerwall of the mold opening. A first parting tool which is connected to a first support element has at least one first parting edge extending around the rim of the mold opening. A second parting tool is connected to a second support element and has at least a second parting edge which cooperates with the first parting edge on the first parting tool. At least one parting tool is made from a different material than its associated support element.

2. Description of the Prior Art

A thermoforming tool of the type with which this invention is concerned is known for producing cup-shaped or lid-shaped end products from a thermoplastically deformable sheet. To that end, the sheet is first pressed into the mold opening in the forming tool, with a die-like prestretcher tool, and then the sheet is brought with compressed air into contact against the inner wall of the mold opening, and finally it is cooled down.

To enable separating the unmolded, cooled-down cup or lid from the remaining sheet, a cutting or stamping device is provided. It includes a cutting edge, which extends around the rim of the mold opening and is embodied on a cutting die plate. On the other side of the sheet, facing the cutting die plate, there is a cutting plate in which there are recesses that are complementary to the cutting edges of the cutting die plate and that are defined by cutting edges. When the cutting plate is moved toward the cutting die plate, the corresponding cutting edges cooperate to shear the finished cup from the remaining sheet.

In the known thermoforming tool, the support elements to which the cutting plate or cutting die plate are fastened are made of lightweight metal, such as aluminum. The cutting plate and the cutting die plate are each made of steel.

Because different materials are used for the parting tool and the corresponding support element, the optimal material for each function can be selected. For the parting tool, for reasons of stability and wear, a comparatively dense, wear-resistant material is used. On the other hand, by using a lightweight metal for the support element, the total weight of the entire structure comprising the parting tool and the support element can be reduced. This in turn makes it possible to achieve faster cycle times.

The reason for this is the fact that during and after the production process, the forming tool and the corresponding support element have to be moved in order to eject the finished workpieces. The lighter the corresponding structure is in weight, the faster this motion can be accomplished, and with less exertion of force. Furthermore, the bearings are also less heavily loaded because of the lower weight, so that either simpler, less-expensive bearings can be used, or the service life of the apparatus is lengthened. Moreover, the total structure, comprising the parting tool and the support element, comes to a stop more quickly after a movement because of the lower weight, which is also favorable for the cycle times.

### OBJECT AND SUMMARY OF THE INVENTION

The object of the present invention is to refine a thermoforming tool of the type described above such that with it, the separation of the end product from the remaining sheet can be done even more reliably. This object is attained in that the first parting tool is not supported or fastened rigidly relative to the first support element, and/or the second parting tool is not supported or fastened rigidly relative to the second support element.

The novel thermoforming tool of the invention makes good, reliable separating action of the parting tool possible, since the exact relative positioning of the cooperating parting edges of the parting tools can be assured. This is attained by means of the aforementioned nonrigid support or fastening. The term “nonrigid” is understood to mean that one parting tool can expand (or shrink) thermally relative to its associated support element and thus without bulging, for instance, or warping. A nonrigid support or fastening of this kind can for instance comprise a floating support.

To enable the finished end product to be separated reliably from the remaining sheet, high dimensional stability of the relative positions of the cooperating parting edges of the parting tools is required. According to the invention, it has been found that despite careful calibration in the factory, this dimensional stability was not always assured. It was discovered that one cause of this was that a thermoforming tool is exposed to a different temperature at the usage site, for instance, from the temperature at its production site. This temperature difference, in structures made of different materials with different coefficients of thermal expansion, can lead to different thermal expansions.

It has furthermore been ascertained according to the invention that such different thermal expansions, in the previously conventional rigid fixation of the parting tool to the support element, can lead to an uneven deformation of the parting tool, such as bulging or warping, which causes shifting in the relative positions of the parting edges. Even permanent distortion of the parting tool relative to the support element can sometimes occur, so that the original relative positions of the parting edges are not regained even after a suitable temperature equalization.

All this is prevented by the nonrigid support or fastening provided according to the invention in which the parting tool can expand unhindered in response to temperature relative to the support element. Uneven deformation is thus precluded. If both parting tools are nonrigidly supported or fastened relative to their support elements, then upon a temperature-caused expansion (on the condition that both parting tools have substantially the same temperature), a change in the absolute positions of the parting edges is possible without producing any change, or at least any significant change, in the relative positions of the parting edges.

If only one of the two parting tools is nonrigidly supported or fastened relative to the corresponding support element, then it can likewise expand unhindered, and after a suitable temperature equalization, it can also return unhindered to the position set exactly at the production site under production conditions. Permanent distortion and an attendant irreversible deformation of the parting tool is prevented reliably by the nonrigid support. In this case—for a suitable “standard temperature”—the parting edge on the parting tool is always in the optimal absolute position intended at the factory, even when different materials are used, because of the nonrigid support or fastening.

In a first refinement of this invention, the nonrigid support or mounting includes a plurality of bending elements which connect the first and/or second parting tool to the first and second support element, respectively, which bending elements are designed such that they are deformed upon a defined maximum temperature-dictated relative motion between the first parting tool and the first support element, and the second parting tool and the second support element, respectively. Such bending elements enable very exact positioning of the parting tool on the support element and nevertheless permit the distortion-free relative motion, provided according to the invention, of the parting tool relative to the support element. Additional self-centering exists when the bending elements are designed such that they deform only elastically.

In a further embodiment, at least one of the bending elements includes a screw and a threaded portion, which threaded portion has a bending portion into which the screw is screwed. A bending element of this kind can be produced inexpensively.

It is also advantageous if the nonrigid support or fastening includes a fixation device, by which the first parting tool is fixed to the first support element and/or the second parting tool is fixed to the second support element, in each case at least translationally and approximately rigidly at some point. A fixation device of this kind assures a place on the parting tool and on the support element whose relative position remains unchanged. Such a place makes possible very accurate, replicable calibration of the parting tool relative to the support element.

The thermoforming tool of the invention is especially inexpensive to construct if the fixation device includes a fixation bolt. Moreover, such a bolt can be fabricated very exactly and introduced into correspondingly exactly dimensioned bores in the support element or in the parting tool. As an alternative to this, it is also possible that the fixation device includes a spot weld (or some other one-piece connection) between the parting tool and the support element.

In an advantageous feature of the novel thermoforming tool, it is also proposed that the nonrigid support or fastening includes at least one guide device by which the first parting tool and/or the second parting tool is guided movably relative to the first support element and the second support element, respectively, translationally along a respective guide axis. By means of a guide device of this kind as well, exact, distortion-free positioning of the parting tool relative to the support element is made possible.

Such a guide device is especially simple to produce if it includes a groove, which is engaged by a corresponding guide element.

Exact positioning of the parting tool relative to the support element, optionally even without a fixation device, is possible whenever two guide devices are provided, whose guide axes are at a right angle to one another. Above all in this case, negative pressure and/or a magnetic force can for instance be used to cause the parting tool to “stick” to its support element.

If a fixation device is provided, it must be located on the guide axis of the guide device, or on the guide axes of the guide devices. The angular position of the parting tool relative to the support element is defined by the guide device or guide devices, while conversely the fixation device defines the translational position of the parting tool relative to the support element.

It is also proposed that at least one low-friction sliding layer is located between one parting tool and the associated support element. This facilitates the distortion-free motion of the parting tool.

In a refinement of this, it is proposed that at least one substrate material is present between one parting tool and the associated support element and has a low-friction sliding layer on both sides. This construction is stable and makes both manufacture and maintenance easier.

Especially when two guide devices but no fixation device are provided, it is preferred that at least one parting tool is urged against the associated support element by negative pressure or a magnetic force. This facilitates the mounting and removal of the parting tool.

### BRIEF DESCRIPTION OF THE DRAWINGS

The invention will be better understood and further objects and advantages thereof will become more apparent from the ensuing detailed description of preferred embodiments taken in conjunction with the drawings, in which:

FIG. 1 is a fragmentary section through a first exemplary embodiment of a thermoforming tool with an upper part and a lower part;

FIG. 2 shows a detail II of the thermoforming tool of FIG. 1;

FIG. 3 is a schematic perspective view of a support element and a parting tool of the lower part of the thermoforming tool of FIG. 1;

FIG. 4 is a schematic fragmentary section taken along the line IV-IV in FIG. 3;

FIG. 5 is an enlarged view of one region of FIG. 4;

FIG. 6 is a partly cutaway view of one region of a second exemplary embodiment of a thermoforming tool;

FIG. 7 shows a detail VII of the thermoforming tool of FIG. 6;

FIG. 8 is a view similar to FIG. 4 of a third exemplary embodiment of a thermoforming tool; and

FIG. 9 is a view similar to FIG. 8 of a fourth exemplary embodiment of a thermoforming tool.

### DESCRIPTION OF THE PREFERRED EMBODIMENTS

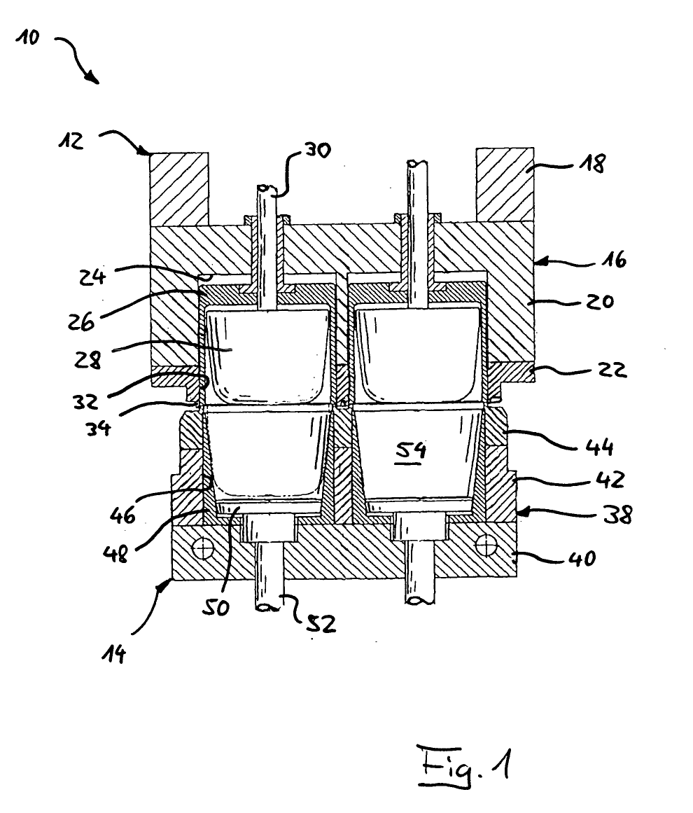

A thermoforming tool identified overall by reference numeral 10 in FIG. 1 includes an upper part 12 and a lower part 14, which can be moved toward and away from one another by a device not shown in the drawing. The upper part 12 includes an upper support element 16, which is made entirely of lightweight metal such as aluminum. An upper bracing structure 18 and an upper cooling block 20 are part of the upper support element 16. An upper stamping plate 22, which is made from steel, is fastened to the upper cooling block 20 of the upper support element 16.

The upper cooling block 20 is penetrated by coolant conduits, not visible in FIG. 1. A plurality of recesses 24 on the order of blind bores are also present in it, and in each of them there is one cup-shaped insert 26, which in operation of the apparatus 10 has a holding-down function. In the position of repose shown in FIG. 1, one cylindrical prestretcher 28, which is rounded on its end toward the lower part 14, is accommodated in each cup-shaped insert 26. The prestretcher 28 is fastened to a push rod 30, which can be moved longitudinally via a device not shown in FIG. 1.

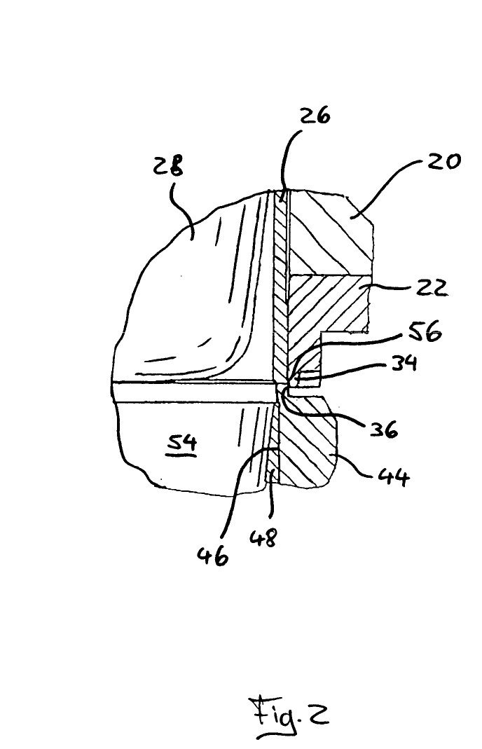

The upper stamping plate 22 has circular openings 32, which are aligned with the outer contour of the cup-shaped inserts and are each surrounded by a respective annular collar 34 (see also FIG. 2). The radially inner free edges of the annular collars 34 are each embodied as an upper parting edge 36. The upper parting edge 36 protrudes somewhat axially past the free edge of the cup-shaped insert 26.

The lower part 14 of the thermoforming tool 10 is constructed similarly to the upper part 12. It includes a lower support element 38, here also preferably of aluminum, which likewise includes a lower bracing structure 40 and a lower cooling block 42. Once again, the lower cooling block 42 is penetrated by coolant conduits, not visible in the drawing. A lower stamping plate 44 of steel is fastened to the top of the lower cooling block 42.

Recesses 46, each approximately aligned with one another, are provided in both the lower cooling block 42 and the lower stamping plate 44, and a forming insert 48 is inserted into each and centered in the lower stamping plate 44 by the corresponding recesses 46. In the position of repose, shown in FIG. 1, of the thermoforming tool 10, there is an ejection plate 50 in the region of the bottom of a forming insert 48; the ejection plate is fastened to a push rod 52, which can be moved in its longitudinal direction by a suitable device, not shown in the drawing.

The forming insert 48 defines a mold opening 54, which corresponds approximately to the outer contour of a workpiece to be produced. The lower stamping plate 44, on its side toward the upper stamping plate 22, has lower parting edges 56 extending around the rim of the mold openings 54 or forming inserts 48. As will be described in further detail hereinafter, these lower parting edges 56 cooperate with the upper parting edges 36 on the upper stamping plate 22.

The thermoforming tool 10 shown in FIGS. 1 and 2 is used to produce plastic cups from a thermoplastically deformable plastic sheet. It is operated as follows:

First, there is an interstice between the upper part 12 and the lower part 14. A sheet of a thermoplastically deformable plastic material (not shown) is passed through this interstice; the sheet has been preheated to its forming temperature of, say approximately 100 (although sheets that have a processing temperature of from 10 to 150° C. can be used). With the sheet stationary, the prestretchers 28 are moved out of the upper part 12 and into the facing mold openings 54 in the lower part 14 as indicated in FIG. 1 by dot-dashed lines. As a result, the plastic sheet is pressed into the mold openings 54 and already comes partly into contact with the inner wall of the corresponding forming inserts 48.

Via compressed-air conduits, not shown in FIGS. 1 and 2, the plastic sheet is additionally acted upon by compressed air and as a result is brought into full contact with the inner wall of a forming insert 48. The plastic sheet resting on the inner wall of a forming insert 48 sets as a result of the cooling of the forming insert 48 by means of the cooling block 42. The prestretcher 28 is now moved back into the position of repose shown in FIG. 1.

To separate the completed cup from the remaining sheet, the upper part 12 is moved against the lower part 14. In the process, the upper parting edges 36 on the upper stamping plate 22 cooperate with the lower parting edges 56 on the lower stamping plate 44 and separate the finished plastic cups, located in the mold openings 54, from the remaining sheet. Depending on the design of the parting edges 36 and 56, this can involve a stamping or a cutting operation.

The upper part 12 is now moved away from the lower part 14 again, so that the parting edges 36 and 56 move free of one another again. Then the lower part 14 is pivoted about a substantially horizontal axis (not shown), and the finished plastic cups are expelled from the mold openings 54 by the corresponding ejection plates 50 into a collecting or stacking container.

To allow the separation of the finished plastic cups from the remaining sheet to proceed quickly and without damage to a finished plastic cup, the parting edges 36 and 56 must be positioned very precisely relative to one another. The gap between the two parting edges 36 and 56 must be very uniform and should typically be in the range of 10 μm. Particularly for a plastic sheet of polypropylene, which has only comparatively little brittleness, clean separation of the finished plastic cup from the remaining sheet cannot be assured otherwise.

For this reason, a very precise positioning of the upper stamping plate 22 on the upper support element 16 and of the lower stamping plate 44 on the lower support element 38, as well as a very precise positioning of the support elements 16 and 38 relative to one another, are done in the factory. This high-precision relative positioning must not be impaired either by shipping or in operation of the thermoforming tool 10.

To assure that, it must be taken into account that the support elements 16 and 38, which in the present exemplary embodiment are also made of aluminum, have a different thermal expansion behavior than the stamping plates 22 and 44 that are made of steel. So that the stamping plates 22 and 44 will not become distorted (bulging or warping, for instance) relative to the respective support elements 16 and 38 if the thermoforming tool 10 is exposed to a different temperature than during the calibration in the factory, the stamping plates 22 and 44 are nonrigidly supported relative to the respective support elements 16 and 38. This is understood to mean that a stamping plate 22 or 44 can expand or shrink in response to heat unhindered relative to its associated support element 16 and 38, respectively, and that upon a return to the initial temperature, it can return to its original outset position unhindered as well. Various possibilities for this kind of nonrigid support are shown as examples in FIGS. 3-8.

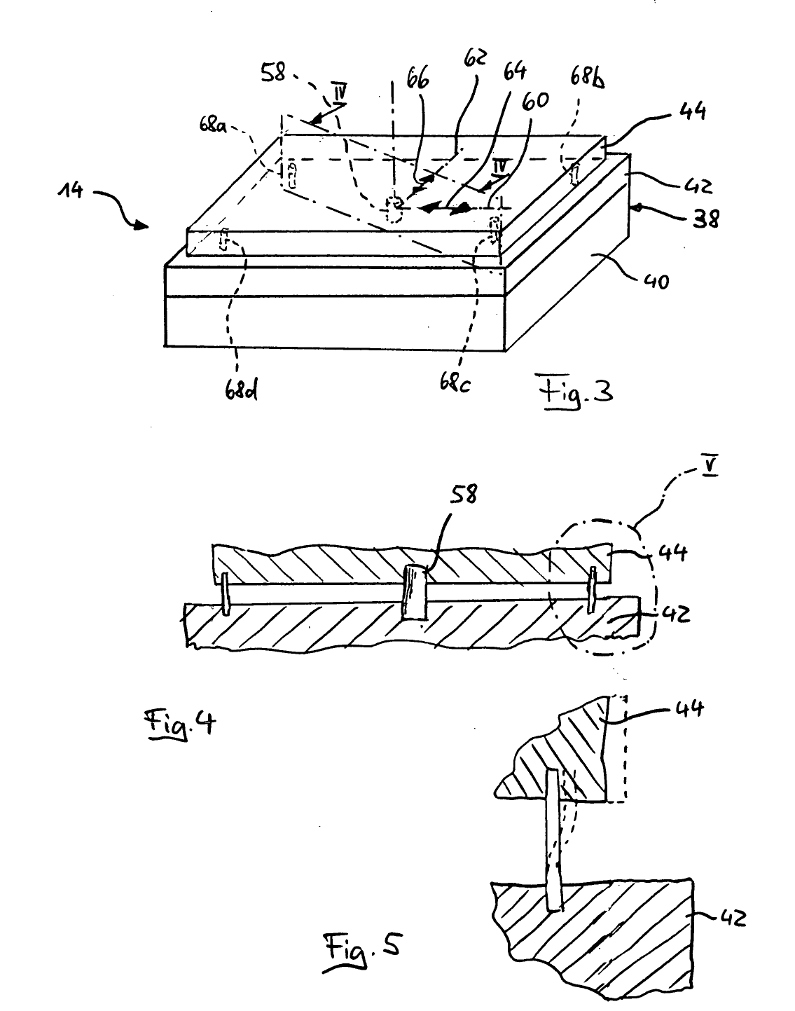

In FIG. 3, the lower part 14 of the forming tool 10 is shown only schematically. The lower support element 38 can be seen, which includes the lower bracing structure 40 and the lower cooling block 42, and the lower stamping plate 44, nonrigidly supported on the lower cooling block 42, can be seen as well. In the exemplary embodiment shown in FIG. 3, the nonrigid support includes a fixation device, which is realized in the form of a central fixation bolt 58 (see FIG. 4). By means of this central fixation bolt 58, the lower stamping plate 44 is fixed translationally and approximately rigidly at a point relative to the lower cooling block 42. However, beginning at the central fixation bolt 58, the lower stamping plate 44 can expand unhindered relative to the lower cooling block 42 along two axes 60 and 62, which are at a right angle to one another and pass through the central fixation bolt 58. The corresponding possibilities of motion are represented by the arrows 64 and 66 in FIG. 3.

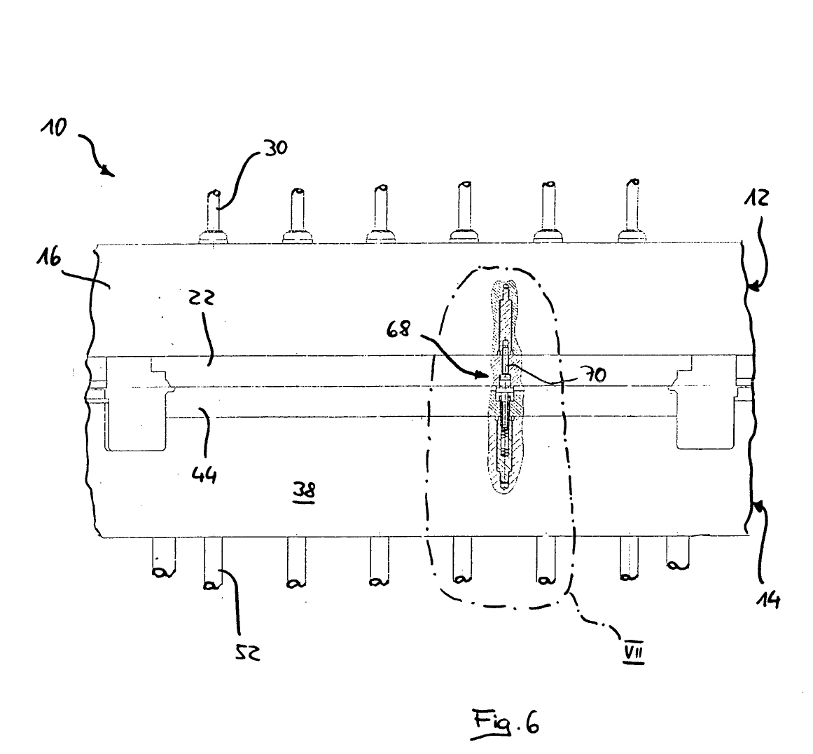

As can be seen from FIGS. 4 and 5, the nonrigid support, shown in FIG. 3, includes a plurality of pinlike bending elements 68a-68d. These connect the lower stamping plate 44 to the lower cooling block 42. They are so stiff that high-precision positioning of the lower stamping plate 44 relative to the lower cooling block 42 is assured.

At the same time, however, they are also designed such that at a defined maximum temperature-dictated relative motion between the lower stamping plate 44 and the lower cooling block 42 of the lower support element 38, they deform only elastically and not plastically. A correspondingly deformed state is shown in dashed lines in FIG. 5.

By means of the nonrigid support, shown in FIGS. 3-5, of the lower stamping plate 44 on the lower cooling block 42 of the lower support element 38, the lower stamping plate 44 cannot become distorted upon a relative motion, caused by a temperature change, relative to the cooling block 42 of the lower support element 38. Moreover, the relative motion between the lower stamping plate 44 and the lower cooling block 42 returns to approximately zero again, and the geometric conditions established at the factory are restored, as soon as the lower part 14 of the thermoforming tool 10 has returned to the “standard temperature” specified at the factory.

It will be understood that the nonrigid support, shown in FIGS. 3-5 for only one stamping plate, can be provided analogously for the other stamping plate as well. This is correspondingly true for the exemplary embodiments described below. It will also be understood that a nonrigid support would also be possible if even only one of the bending elements 68, without the fixation bolt 58, were used.

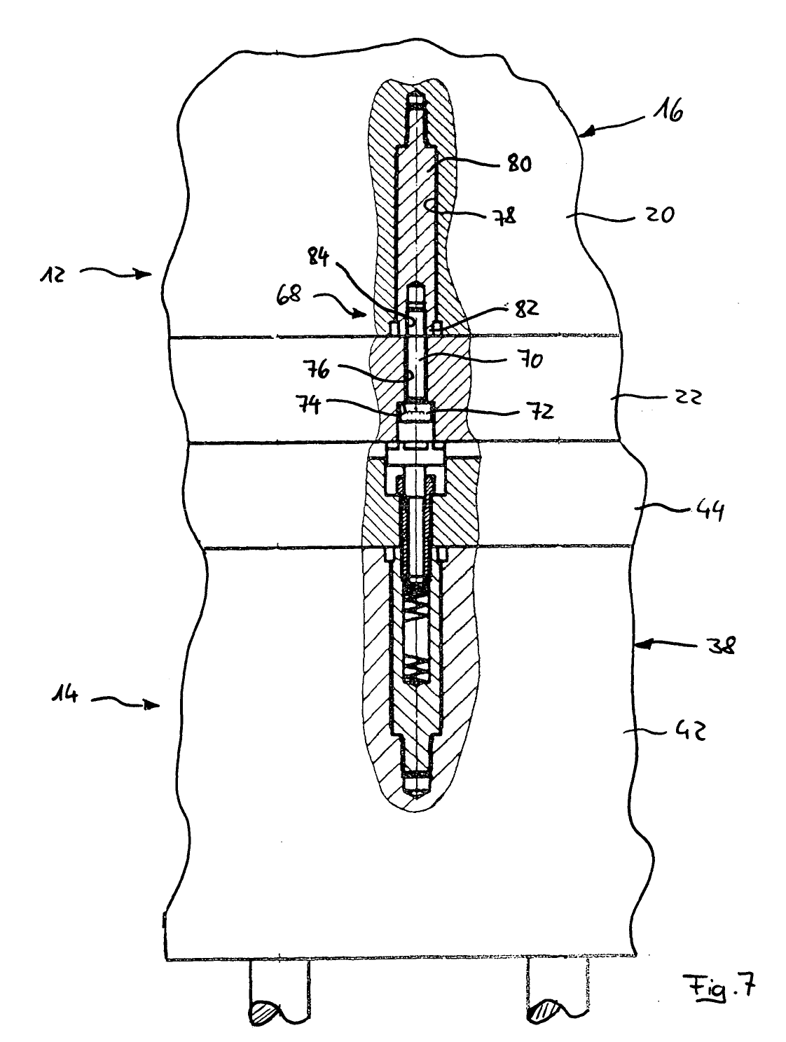

In FIGS. 6 and 7, an alternative and especially preferred embodiment of a bending element 68 is shown, with which the upper stamping plate 22 is fastened to the upper cooling block 20 of the upper support element 16. Those elements and regions of FIGS. 6 and 7 that have functions equivalent to elements and regions of the exemplary embodiment shown in FIGS. 1-5 are identified by the same reference numerals. They will not be explained again in detail.

The fastening of the upper stamping plate 22 to the cooling block 20 is effected, in the thermoforming tool 10 shown in FIGS. 6 and 7, by means of a plurality of screws 70, whose head 72 is braced on a shoulder 74 of a stepped through bore 76 in the upper stamping plate 22 (see FIG. 7). A threaded insert 80 is screwed into a blind threaded bore 78 in the cooling block 20. The end region, toward the stamping plate 22, of this insert is spaced apart from the wall of the blind threaded bore 78 and forms a collarlike bending portion 82.

In the threaded insert 80, there is a comparatively short threaded bore 84, into which the screw 70 is screwed. The threaded bore 84 and the connection between the screw 70 and the threaded insert 80 are essentially located in the region of the bending portion 82. If upon a temperature change, because of the different coefficients of thermal expansion, a relative motion occurs between the stamping plate 22 and the cooling block 20, then the bending portion 82 of the threaded insert 80, and with it the screw 70, can bend elastically, thereby preventing a deformation of the stamping plate 22.

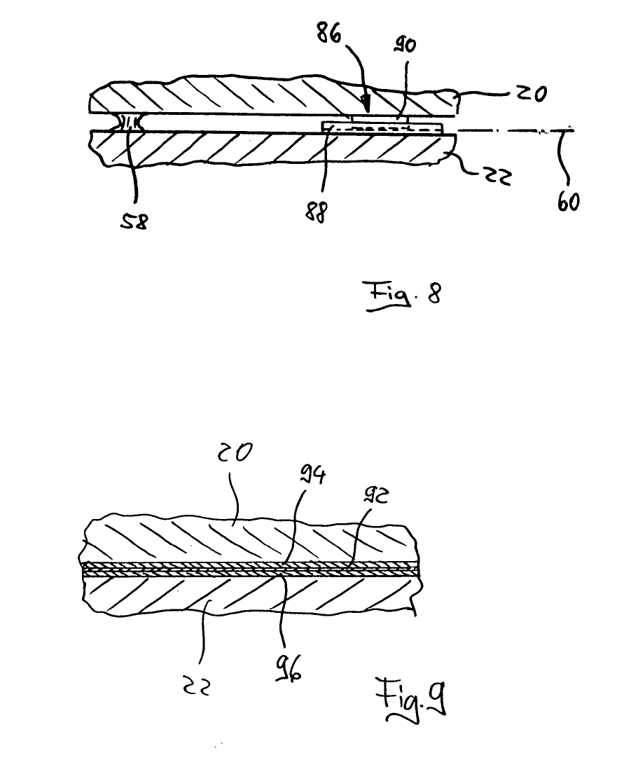

In FIG. 8, yet another version of a nonrigid support between the upper stamping plate 22 and the upper cooling block 20 is shown. Once again, those elements and regions that have equivalent functions to elements and regions of the exemplary embodiments shown in FIGS. 1-7 are identified by the same reference numerals and will not be explained again in detail.

In the exemplary embodiment of a thermoforming tool 10 shown in FIG. 8, the upper stamping plate 22 is fixed relative to the upper cooling block 20 at a point by a spot weld 58. However, a guide device 86 is additionally present, by which the upper stamping plate 22 is guided translationally and movably relative to the upper cooling block 20 along a guide axis 60 (see FIG. 3) located in the plane of the drawing. The guide device 86 includes a sliding block 88, which is fastened to the upper stamping plate 22 and which is engaged by a suitably complementary guide element 90 that is fastened to the cooling block 20. In an axis perpendicular to the plane of the drawing in FIG. 8, there is a further guide device, which enables a motion of the stamping plate 22 along a guide axis 62 (see FIG. 3). The guide axes 60 and 62 are thus at a right angle to one another and pass through the welding point 58.

If a guide device as in the exemplary embodiment shown in FIG. 8, which has two guide axes orthogonal to one another, is used, then it is optionally possible to dispense with a rigid fixation device. The adhesion between the two elements can then be accomplished for instance by means of negative pressure and/or a magnetic force instead.

In FIG. 9, yet another version of a nonrigid support between the upper stamping plate 22 and the upper cooling block 20 is shown. Once again, those elements and regions that have equivalent functions to elements and regions of the exemplary embodiments shown in FIGS. 1-8 are identified by the same reference numerals and will not be explained again in detail.

In FIG. 9, a thin substrate material 92 (for instance a thin metal sheet) is disposed between the stamping plate 22 and the upper cooling block 20; it is provided on both sides with a low-friction slide coating 94 and 96, respectively, for instance of Teflon. As a result, sliding between the stamping plate 22 and the upper cooling block 20 with very low friction is made possible, with at the same time only a slight spacing between the two elements. As in the above exemplary embodiments already, it is naturally possible for the teaching of FIG. 9 to be applied to the conditions in the lower part 14 of the thermoforming tool 10.

The foregoing relates to preferred exemplary embodiments of the invention, it being understood that other variants and embodiments thereof are possible within the spirit and scope of the invention, the latter being defined by the appended claims.

I claim:

1. A thermoforming tool (10), comprising
a forming tool (12), in which there is at least one mold opening (54),
means (28) with which a plastically deformable sheet material can be brought into contact with the inner wall of the mold opening (54),
a first parting tool (22), which is connected to a first support element (16) and having at least one first parting edge (36) extending around the rim of the mold opening (54),
a second parting tool (44), which is connected to a second support element (38) and having at least a second parting edge (56) which cooperates with the first parting edge (36) on the first parting tool (22),
at least one parting tool (22, 44) being made from a different material than its associated support element (16, 38), and
means nonrigidly supporting or fastened the first parting tool (22) relative to the first support element (16), and/or nonrigidly supporting or fastening the second parting tool (44) relative to the second support element (38).

2. The thermoforming tool (10) according to claim 1, wherein the nonrigid support or fastening means comprises a plurality of bending elements (68) connecting the first and/or second parting tool (22; 44) to the first and second support element (16; 38), respectively, the bending elements being designed such that they are deformed upon a defined maximum temperature-dictated relative motion between the first parting tool (22) and the first support element (16), and the second parting tool (44) and the second support element (38), respectively.

3. The thermoforming tool (10) according to claim 2, wherein at least one of the bending elements (68) includes a screw (70) and a threaded portion (80), which threaded portion has a bending portion (82), into which the screw (70) is screwed.

4. The thermoforming tool (10) according to claim 1, wherein the nonrigid support or fastening comprises a fixation device (58), by which the first parting tool (22) is fixed to the first support element (16) and/or the second parting tool (44) is fixed to the second support element (38), in each case at least translationally and approximately rigidly at some point.

5. The thermoforming tool (10) according to claim 2, wherein the nonrigid support or fastening comprises a fixation device (58), by which the first parting tool (22) is fixed to the first support element (16) and/or the second parting tool (44) is fixed to the second support element (38), in each case at least translationally and approximately rigidly at some point.

6. The thermoforming tool (10) according to claim 3, wherein the nonrigid support or fastening comprises a fixation device (58), by which the first parting tool (22) is fixed to the first support element (16) and/or the second parting tool (44) is fixed to the second support element (38), in each case at least translationally and approximately rigidly at some point.

7. The thermoforming tool (10) according to claim 4, wherein the fixation devicecomprises a fixation bolt (58).

8. The thermoforming tool (10) according to claim 5, wherein the fixation devicecomprises a fixation bolt (58).

9. The thermoforming tool (10) according to claim 6, wherein the fixation devicecomprises a fixation bolt (58).

10. The thermoforming tool (10) according to claim 4, wherein the fixation device comprises a spot weld (58).

11. The thermoforming tool (10) according to claim 1, wherein the nonrigid support or fastening comprises at least one guide device (86), by which the first parting tool (22) and/or the second parting tool (44) is guided movably relative to the first support element (16) and the second support element (38), respectively, translationally along a respective guide axis (60, 62).

12. The thermoforming tool (10) according to claim 11, wherein the guide device (86) includes a groove (88), which is engaged by a corresponding guide element (90).

13. The thermoforming tool (10) according to claim 11, comprising two guide devices (86) whose guide axes (60, 62) are at a right angle to one another.

14. The thermoforming tool (10) according to claim 12, comprising two guide devices (86) whose guide axes (60, 62) are at a right angle to one another.

15. The thermoforming tool (10) according to claim 4, wherein the nonrigid support or fastening comprises at least one guide device (86), by which the first parting tool (22) and/or the second parting tool (44) is guided movably relative to the first support element (16) and the second support element (38), respectively, translationally along a respective guide axis (60, 62), and wherein the guide axis or axes (60, 62) of the guide device or guide devices (86), as applicable, pass through the fixation device (58).

16. The thermoforming tool (10) according to claim 5, wherein the nonrigid support or fastening comprises at least one guide device (86), by which the first parting tool (22) and/or the second parting tool (44) is guided movably relative to the first support element (16) and the second support element (38), respectively, translationally along a respective guide axis (60, 62), and wherein the guide axis or axes (60, 62) of the guide device or guide devices (86), as applicable, pass through the fixation device (58).

17. The thermoforming tool (10) according to claim 6, wherein the nonrigid support or fastening comprises at least one guide device (86), by which the first parting tool (22) and/or the second parting tool (44) is guided movably relative to the first support element (16) and the second support element (38), respectively, translationally along a respective guide axis (60, 62), and wherein the guide axis or axes (60, 62) of the guide device or guide devices (86), as applicable, pass through the fixation device (58).

18. The thermoforming tool (10) according to claim 1, further comprising at least one low-friction sliding layer (94, 96) located between one parting tool (22) and the associated support element (20).

19. The thermoforming tool (10) according to claim 18, further comprising at least one substrate material (92) between one parting tool (22) and the associated support element (20), the substrate material having a low-friction sliding layer (94, 96) on both sides.

20. The thermoforming tool (10) according to claim 1, wherein at least one parting tool is urged against the associated support element by negative pressure or a magnetic force.
